(19) United States
(12) Patent Application Publication
(10) Pub. No.: US 2019/0040896 A1
(43) Pub. Date: Feb. 7, 2019

(54) HYDRAULIC CLAMPING DEVICE, SYSTEM COMPRISING SUCH DEVICE AND METHOD OF INTERCONNECTING A HUB AND A SHAFT

(71) Applicant: ETP TRANSMISSION AB, LINKÖPING (SE)

(72) Inventor: Peter Kremsl, LINKÖPING (SE)

(21) Appl. No.: 15/758,960

(22) PCT Filed: Sep. 21, 2016
(86) PCT No.: PCT/EP2016/072382

§ 371 Date: Mar. 9, 2018

(30) Foreign Application Priority Data
Sep. 23, 2015 (SE) 1551223-9

(51) Int. Cl. F16B 21/18; F16D 1/08

(52) U.S. Cl. CPC F16B 21/186; F16D 1/116; F16D 1/0805

(57) ABSTRACT

The present disclosure provides a hydraulic clamping device, including an inner sleeve, an outer sleeve, and a pressure chamber provided radially between the inner and outer sleeves and adapted for causing at least one of the inner and outer sleeves to deform radially on pressurization of the pressure chamber. The clamping device further includes retaining means, arranged to prevent axial displacement of the inner and outer sleeves relative to each other by interaction with locking surfaces provided on the inner and outer sleeves, respectively.

### TECHNICAL FIELD

The present document relates to a hydraulic clamping device and to a method of interconnecting a shaft with another shaft or with a hub.

The document also relates to a system comprising such a clamping device.

### BACKGROUND

Hydraulic friction couplings, or hydraulic clamping devices, are used to provide a mechanical connection between two machine parts, which can generally be referred to as a shaft and a hub, the connection allowing power and/or torque to be transmitted between the shaft and the hub.

The terms “hub” and “shaft”, as used herein, should be understood as schematic terms, i.e. they shall be deemed to apply to any type of structures that are attached to each other by introduction of a shaft into a recess and preventing relative rotation of the shaft and recess.

Shaft-and-hub joints are used for industrial purposes in various applications, for example in mechanical engineering, as tool holders (chucks) in machine tools, and as safety locks in hydraulic and pneumatic cylinders. Joints of this type often have to meet exacting requirements regarding precision, consecutive working properties and safety, while at the same time satisfying demands for a good overall economy, sufficient compactness and rapid assembly.

Hydraulic clamping devices usually comprise an inner sleeve for frictional locking to a shaft surrounded by the inner sleeve, and an outer sleeve for frictional locking to a hub. One type of known friction couplings comprises a pressure chamber, which by means of contact surfaces bearing against the sleeves transmits a force to said sleeves. By making the sleeves from an expandable material it is possible, using the pressure in the pressure chamber, to control a deformation of the sleeves to obtain frictional locking to a machine part which surrounds the sleeves or is housed in the sleeves, such as a hub or a shaft.

Hydraulic clamping devices are known from e.g. WO2008/054294A1. The working principles of such clamping devices are well known as such.

While there are many different types of hydraulic clamping devices, there remain applications where hydraulic clamping devices presently cannot be used, e.g. since they take up too much space, or where they can be used, but where it is desirable to save space and/or reduce weight.

It would be desirable to be able to integrate the hydraulic clamping device into the device which it is to operate in or on. However, hydraulic clamping devices present challenges in terms of selection of materials and in terms of tolerances, which cannot always be combined with the production technology that is used to form the rest of the product.

Hence, there is a need for a hydraulic clamping device which may be readily integrated with the device which it is to operate in or on.

### SUMMARY

It is an object of the present disclosure to provide a hydraulic clamping device which can be readily integrated with a shaft axle that it is to operate on to provide a connection to a hub.

The invention is defined by the appended independent claims, with embodiments being set forth in the dependent claims, in the following description and in the drawings.

According to a first aspect, there is provided a hydraulic clamping device, comprising an inner sleeve, an outer sleeve, a pressure chamber provided radially between the inner and outer sleeves and adapted for causing at least one of the inner and outer sleeves to deform radially on pressurization of the pressure chamber. The clamping device further comprises retaining means, arranged to prevent axial displacement of the inner and outer sleeves relative each other by interaction with locking surfaces provided on the inner and outer sleeves, respectively.

By using retaining means interacting with locking surfaces, it is possible to combine materials which are not possible to connect together by welding. Moreover, assembly of the clamping device can be made less cumbersome, since no welding is needed, which reduces the need for special skills and equipment for the assembly operation.

Such retaining means may comprise parts which are integrated with the sleeves and/or form one or more separate parts.

Non-limiting examples of retaining means comprise threaded connectors, bayonet connectors, separate retaining devices and integrated snap-locking devices, such as radially resilient parts which may be attached to or integrated with one of the sleeves.

Specifically, the retaining means may comprise a resilient retaining device, which may be radially resilient.

In the clamping device, the inner sleeve may present a ramp surface, arranged axially between a portion of the inner sleeve which provides the pressure chamber and the locking surface associated with the inner sleeve. The ramp surface may thus form a transition from the inner sleeve to the locking surface.

The outer sleeve may comprise a ramp surface, arranged axially between a portion of the outer sleeve which provides the pressure chamber and the locking surface associated with the outer sleeve.

The ramp surface may thus form a transition from the inner sleeve to the locking surface. In particular where both inner and outer sleeves have ramp surfaces, these ramp surfaces may cooperate.

The clamping device may further comprise a retaining groove, a wall portion of which forms the locking surface.

The clamping device may further comprise at least one sealing device, arranged to seal the pressure chamber.

Typically, two sealing devices are provided, one providing sealing axially in respective axial directions from the pressure chamber.

The clamping device may further comprise at least one annular groove for receiving the sealing device.

The groove may be provided in the inner sleeve, in the outer sleeve or in both. Typically, the number of annular grooves may coincide with the number of sealing devices.

The retaining means may comprise parts, arranged on the respective sleeve, which are designed to engage by an at least partial rotary motion about a central axis of the sleeves.

The retaining means may comprise a radially resilient part which is integrated with one of the sleeves and which carries a locking element that provides one of the locking surfaces.

At least one of the inner and outer sleeves is integrated with, preferably formed in one piece with, a hub or a shaft.

Hence, for example, the inner sleeve may be formed in one piece with a shaft, that is, an end portion of the shaft may be hollow and provided with the associated locking surface.

The clamping device as claimed in any one of the preceding claims, wherein one of the inner and outer sleeves is arranged to be radially deformable to provide the clamping action, and wherein the other one of the inner and outer sleeves is radially substantially rigid.

The other one of the inner and outer sleeves may present a portion of decreased radial thickness, so as to allow limited radial deformation.

By allowing such radial deformation, it is possible to reduce the product's temperature dependence. That is, it is possible to reduce the pressure increasing effect obtained in the pressure chamber when the product is subjected to an increase in temperature.

According to a second aspect, there is provided a system comprising a hub, a shaft, and a clamping device as described above. In the system, at least one of the inner sleeve and the outer sleeve is integrated with, preferably formed in one piece with, one of the hub and the shaft.

According to a third aspect, there is provided a method of making a hydraulic clamping device. The method comprises providing an inner sleeve having an axial locking surface on its outside, and providing an outer sleeve having an axial locking surface on its inside. The inner and outer sleeves are adapted to provide a pressure chamber between the inner sleeve and the outer sleeve, whereby at least one of the sleeves is radially deformable for providing a clamping action in response to a pressure increase in the pressure chamber. The method further comprises axially introducing the inner sleeve into the outer sleeve until interaction with at least one of the axial locking surfaces is achieved, to prevent axial displacement of the inner and outer sleeves relative each other.

The method may comprise providing a resilient retaining device, wherein the retaining device provides said interaction with at least one of the axial locking surfaces

In the method, the retaining device may be provided on one of the inner and outer sleeves and wherein the other one comprises a ramp surface which is arranged to cause the retaining device to deform during a part of the axial introduction, and wherein the retaining device, during a subsequent part of the axial introduction is allowed to spring at least partly back towards its original state, whereby the retaining device is brought into engagement with at least one of the locking surfaces.

The axial introduction may comprise a rotation about a central geometric axis of the sleeves, said rotation leading to said interaction with at least one of the axial locking surfaces. Such rotation may provide a threaded-type connection or a bayonet-type connection.

As another alternative, the axial introduction may comprise causing a radially resilient part, which is integrated with one of the sleeves and which carries a locking element, to engage one of the locking surfaces.

### BRIEF DESCRIPTION OF THE DRAWINGS

FIG. 1 is a schematic exploded view of a shaft-hub connection including a clamping device.

FIG. 2 is a schematic perspective view of a clamping device according to an embodiment of the present concept.

FIGS. 3a-3c are different schematic views of the clamping device of FIG. 2.

FIGS. 4a-4b are schematic diagrams of different configurations in which a clamping device C according to the present disclosure may be used.

### DETAILED DESCRIPTION

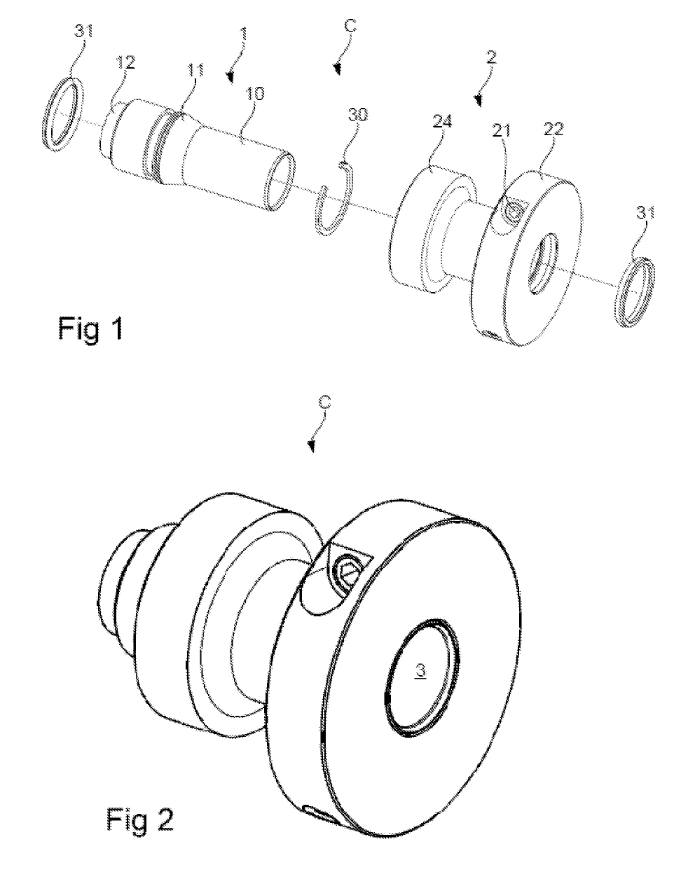

FIG. 1 schematically illustrates an exploded view of a shaft-shaft connection including a clamping device C. The connection comprises an inner sleeve 1, which includes a clamping portion 10, a locking portion 11 and a shaft portion 12; an outer sleeve 2, which includes a housing portion 22 enclosing an actuation mechanism 21, a locking portion 24; first and second sealing rings 31, 32; and a retaining ring 30.

The receptacle formed radially inside the clamping portion 10 is adapted to receive and frictionally connect to an end portion of a second shaft (not shown).

A pressure chamber 4 is formed between the inner and outer sleeves 1, 2. Hence, when the pressure chamber is pressurized, the clamping portion will deform radially inwardly, whereby a clamping force is provided against the second shaft.

While the present example relates to a clamping device wherein a first shaft 12 is integrated with the inner sleeve 1, and the outer sleeve 2 is used for providing the actuation mechanism, it is understood that it would be possible to instead integrate a shaft or hub portion with the outer sleeve 2. It would also be possible to integrated shafts with both sleeves 1, 2.

FIG. 2 schematically illustrates the shaft-shaft connection disclosed in FIG. 1 in an assembled state.

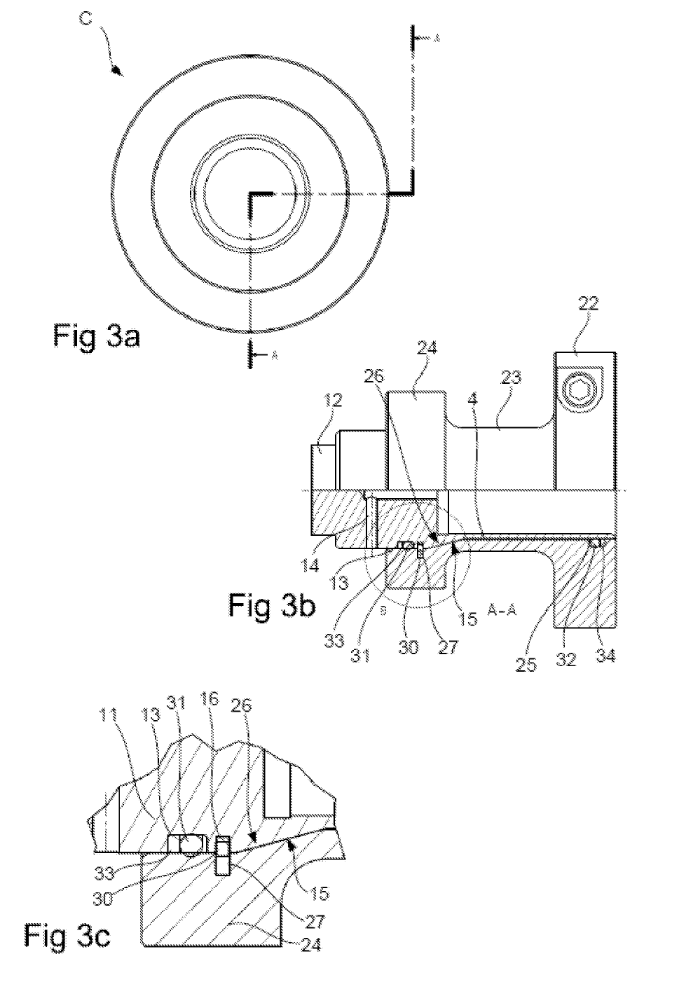

FIG. 3a is a view of the clamping device C as seen from the shaft side.

FIG. 3b is a partial sectional view taken along the line A-A in FIG. 3a.

As can be seen in FIGS. 2, 3a and 3b, the inner sleeve 1 comprises a thin, cylindrical clamping portion 10, a locking portion 11 and a shaft portion 12 (which can be of arbitrary length and design).

An inside of the clamping portion 10 defines a receptacle 3 (FIG. 2), the form and size of which is adapted for receiving the second shaft end. In the present example, the receptacle 3 is substantially cylindrical in shape.

In the illustrated embodiment, all portions 10, 11, 12 are formed in one piece. However, it is possible to form two or more of these portions as separate parts, which are connected by e.g. welding.

The locking portion 11 comprises a first ramp surface 15, which in the illustrated example is a conical surface and a locking groove 16, the form, width and depth of which is designed to receive a locking device 30. The locking groove provides at least one, preferably two, axially operating locking surfaces.

In the illustrated example, the locking groove 16 is an annular groove, which is situated immediately at one axial end of the first ramp surface 15. The other axial end of the first ramp surface 15 connects directly to the clamping portion 10 of the inner sleeve.

The locking device 30 may be any type of locking ring. In the present example, the locking device is an essentially C-shaped ring, which can be formed of a metallic material, such as spring grade steel, and which is elastically deformable.

The locking portion 11 further comprises a sealing groove 13, which is adapted to receive a sealing device 31, which here has the shape of an O-ring. A sealing device support ring may 33 also be provided in the sealing groove 13, preferably axially outside the sealing device 31, as seen from the pressure chamber 4.

The sealing devices used herein may be provided as a separate part, such as an O-ring. The O-ring may have any cross section, including circular, elliptic or polygonal. As an alternative, a sealing device may be formed in situ, e.g. by application of a hardening or setting compound. Such an in situ formed sealing device may be allowed to harden or seal before or after assembly of the sleeves.

The O-ring may be formed from a rubber elastic material, including rubber materials, polyurethane and thermoplastic elastomeric materials.

A vent channel 14 is provided, for venting air that would otherwise be trapped in the receptacle 3.

The outer sleeve 2 comprises a housing portion 22, and a locking portion 24. Optionally, the outer sleeve 2 may comprise a reduced outer diameter portion 23, as illustrated in FIG. 3b.

At the housing portion 22, which in the illustrated example forms a distal portion of the clamping device C, an actuation mechanism 21 may be integrated. The actuating mechanism 21 may comprise a piston, which is movable in a reservoir chamber that is in fluid communication with the pressure chamber, such that fluid may be forced into the pressure chamber 4 to cause the clamping portion 10 of the inner sleeve 1 to deform radially inwardly, whereby locking of the second shaft end is affected.

At the distal end of the clamping device C, there is also provided a sealing groove 25, which is adapted to receive a sealing device 32, which here has the shape of an O-ring. A sealing device support ring 34 may also be provided in the sealing groove 25.

The locking portion 24 comprises a second ramp surface 26, which in the illustrated example is a conical surface, and a locking groove 27, the form, width and depth of which is designed to receive the locking device 30.

The locking groove 27 provides at least one, preferably two, axially operating locking surfaces.

The reduced outer diameter portion 23 may be provided radially outside the pressure chamber, over an axial length corresponding to at least 50% of the axial length of the pressure chamber 4, preferably at least 60% or at least 70%.

The reduced outer diameter portion 23 may provide a material thickness which is on the order of 3-10 times a thickness of the inner sleeve at the pressure chamber 4.

The reduced outer diameter portion may further have an outer diameter which is on the order of 20-80% of that of the housing portion 22, preferably 30-60% or about 40-50%. Alternatively, or as a supplement, the reduced outer diameter portion may further have an outer diameter which is on the order of 40-90% of that of the locking portion 24, preferably 50-80% or about 55-65%.

FIG. 3c is a magnified view of the encircled area in FIG. 3b, wherein the locking portions 11, 24 are more clearly visible.

The description will now be directed to the assembly of the clamping device.

As noted before, the inner sleeve 1 may be provided as an integrated part of, e.g. a first shaft. The inner sleeve 1 thus forms a hollow end portion of a shaft.

A first sealing device 31 is mounted externally in the sealing groove 13 provided on the locking portion 11 of the inner sleeve 1. Optionally a sealing device support ring 32 may also be mounted at this stage.

A retaining ring 30 is mounted internally in the locking groove 27 in the outer sleeve 2. The retaining ring 30 may be mounted such that it can expand further once received in the locking groove 27. It is conceivable to mount the retaining ring externally in the locking groove 16 instead.

A second sealing device 32 is mounted internally in the sealing groove 25 of the outer sleeve 2. Optionally a sealing device support ring 34 may also be mounted at this stage.

The inner sleeve 1 is then introduced with its distal portion into the proximal portion of the outer sleeve 2 and the sleeves 1, 2 are then axially displaced relative to each other.

Once the retaining ring 30 reaches the first ramp surface 15 of the inner sleeve 1, it will begin to expand and will continue this expansion until it reaches the locking groove 16 of the inner sleeve 1, where it will spring back and engage both locking grooves 16, 27.

At this point, both first and second sealing devices 31, 32 are being compressed radially and the locking ring 30 will prevent any axial movement (but for some small play) between the inner and outer sleeves 1, 2.

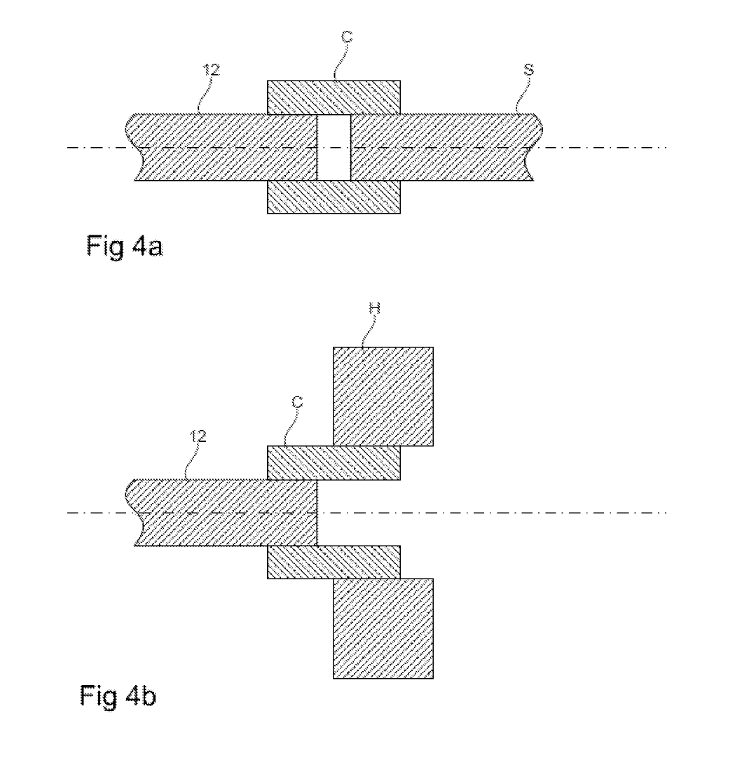

Referring to FIG. 4a, there is disclosed a first system wherein a clamping device C according to the present disclosure may be used.

The system comprises a first shaft 12, a second shaft S and a clamping device C.

As disclosed above, the first shaft 12 may be integrated with one of the sleeves of the clamping device, such as the inner sleeve or the outer sleeve. Referring to FIG. 4b, there is disclosed a second system, wherein a clamping device C according to the present disclosure may be used.

The system comprises a first shaft 12, a hub H and a clamping device C.

In one embodiment, the first shaft 12 may be integrated with the inner or the outer sleeve of the clamping device.

In another embodiment, the hub H may be integrated with the inner or the outer sleeve of the clamping device.

In another embodiment, instead of using a resilient retaining device in the form of a separate component, it is possible to provide locking by e.g. one or more radially resilient locking tongues, attached to, or integrated with, one of the sleeves. Such locking tongues may carry a respective locking element providing one of the locking surfaces and it may be radially resilient so as to be pushed radially inwardly or outwardly on axial introduction of the inner sleeve into the outer sleeve and then to return to its original position when the locking element reaches e.g. a corresponding locking groove.

In yet another embodiment, a threaded connection may be provided, whereby the locking surfaces are provided by the threads.

The system disclosed herein may be useful in a variety of applications. Non-limiting examples of such applications include a pump, wherein one of the inner and the outer sleeve is integrated with a motor shaft; a coupling, wherein one of the inner and the outer sleeve is integrated with an input or output shaft; a brake, wherein one of the inner and the outer sleeve is integrated with a drive shaft; or a gearbox, wherein one of the inner and the outer sleeve is integrated with an input or output shaft.

1. A hydraulic clamping device, comprising:
an inner sleeve,
an outer sleeve, and
a pressure chamber provided radially between the inner and outer sleeves and adapted for causing at least one of the inner and outer sleeves to deform radially on pressurization of the pressure chamber,
retaining means, arranged to prevent axial displacement of the inner and outer sleeves relative to each other by interaction with locking surfaces provided on the inner and outer sleeves, respectively, and
a retaining groove, a wall portion of which forms the locking surface.

2. The clamping device as claimed in claim 1, wherein the retaining means comprise a resilient retaining device.

3. The clamping device as claimed in claim 1, wherein the inner sleeve presents a ramp surface, arranged axially between a portion of the inner sleeve which provides the pressure chamber and the locking surface associated with the inner sleeve.

4. The clamping device as claimed in claim 1, wherein the outer sleeve comprises a ramp surface, arranged axially between a portion of the outer sleeve which provides the pressure chamber and the locking surface associated with the outer sleeve.

5. (canceled)

6. The clamping device as claimed in claim 1, further comprising at least one sealing device, arranged to seal the pressure chamber.

7. The clamping device as claimed in claim 6, further comprising at least one annular groove for receiving the sealing device.

8. A hydraulic clamping device, comprising:
an inner sleeve,
an outer sleeve,
a pressure chamber provided radially between the inner and outer sleeves and adapted for causing at least one of the inner and outer sleeves to deform radially on pressurization of the pressure chamber, and
retaining means, arranged to prevent axial displacement of the inner and outer sleeves relative to each other by interaction with locking surfaces provided on the inner and outer sleeves, respectively,
wherein the retaining means comprises parts, arranged on the respective sleeve, which are designed to engage by an at least partial rotary motion about a central axis of the sleeves.

9. A hydraulic clamping device, comprising:
an inner sleeve,
an outer sleeve,
a pressure chamber provided radially between the inner and outer sleeves and adapted for causing at least one of the inner and outer sleeves to deform radially on pressurization of the pressure chamber, and
retaining means, arranged to prevent axial displacement of the inner and outer sleeves relative to each other by interaction with locking surfaces provided on the inner and outer sleeves, respectively,
wherein the retaining means comprises a radially resilient part which is integrated with one of the sleeves and which carries a locking element that provides one of the locking surfaces.

10. The clamping device as claimed in claim 1, wherein at least one of the inner and outer sleeves is integrated with, preferably formed in one piece with, a hub or a shaft.

11. The clamping device as claimed in claim 1, wherein one of the inner and outer sleeves is arranged to be radially deformable to provide the clamping action, and wherein the other one of the inner and outer sleeves is radially comparatively rigid.

12. The clamping device as claimed in claim 9, wherein the other one of the inner and outer sleeves presents a portion of decreased radial thickness, so as to allow limited radial deformation.

13. A system comprising:
a hub,
a shaft, and
a clamping device as claimed in claim 1,
wherein at least one of the inner sleeve and the outer sleeve is integrated with one of the hub and the shaft.

14. A method of making a hydraulic clamping device, comprising:
providing an inner sleeve having an axial locking surface on its outside, and
providing an outer sleeve having an axial locking surface on its inside,
wherein the inner and outer sleeves are adapted to provide a pressure chamber between the inner sleeve and the outer sleeve, whereby at least one of the sleeves is radially deformable for providing a clamping action in response to a pressure increase in the pressure chamber, and
axially introducing the inner sleeve into the outer sleeve until interaction with at least one of the axial locking surfaces is achieved to prevent axial displacement of the inner and outer sleeves relative each other.

15. The method as claimed in claim 14, further comprising: providing a resilient retaining device, wherein the retaining device provides said interaction with at least one of the axial locking surfaces.

16. The method as claimed in claim 15, wherein the retaining device is provided on one of the inner and outer sleeves and wherein the other one comprises a ramp surface which is arranged to cause the retaining device to deform during a part of the axial introduction, and wherein the retaining device, during a subsequent part of the axial introduction is allowed to spring at least partly back towards its original state, whereby the retaining device is brought into engagement with at least one of the locking surfaces.

17. The method as claimed in claim 14, wherein the axial introduction comprises a rotation about a central geometric axis of the sleeves, said rotation leading to said interaction with at least one of the axial locking surfaces.

18. The method as claimed in claim 14, wherein the axial introduction comprises causing a radially resilient part, which is integrated with one of the sleeves and which carries a locking element, to engage one of the locking surfaces.
